(19) United States
(12) Patent Application Publication
(10) Pub. No.: US 2004/0094214 A1
(43) Pub. Date: May 20, 2004

(54) Piston pressure balancer for hot and cold water mixer valves

(76) Inventor: Carlo Ottelli, Brescia (IT)

Correspondence Address: McGLEW AND TUTTLE, John James McGlew, Scarborough Station, Scarborough, NY, 10510-0827, US

(21) Appl. No.: 10/712,724

(22) Filed: Nov. 13, 2003

Related U.S. Application Data
(63) Continuation-in-part of application No. 10/060,507, filed on Jan. 30, 2002.

(51) Int. Cl. F16K 11/078

(52) U.S. Cl. 137/625.17

(57) ABSTRACT

This invention relates to a pressure balancer to associate with a mixer valve, comprising a balancer body which defines a chamber and a piston in said chamber. The chamber has a middle section between two side sections, where the middle section has a larger diameter than the side sections. The piston has an intermediate flange joined at opposite ends to two side flanges, where the intermediate flange has an external diameter compatible with that of the middle section of the chamber and features a peripheral seal on the inner surface of the middle section, and the side flanges each has a diameter corresponding to that of the side sections of chamber.

### FIELD OF THE INVENTION

This invention concerns a pressure balancer for devices intended for controlling the supply of two liquids with different temperatures and pressures, more specifically hot and cold water mixer valves featuring variable openings for controlling the temperature and the quantity of the supplied water.

### STATE OF THE ART

The hot and cold water mixer valves of the type considered here are well known, just as equally well known are the various embodiments of pressure balancers that can be associated or integrated with the mixer valves.

Generally speaking, a mixer valve features two inlets to separately receive hot and cold water from the respective distribution mains, a mixing chamber for the two types of water and a single mixed water outlet. The incoming hot and cold water can be mixed in varying proportions according to the temperature of the water to be supplied. It can however occur that the pressures of the two types of water at the valve inlets varies, in which case, without control, the flows and ratios of the hot and cold waters to be mixed, and consequently also the temperature of the supplied water, would also vary.

A pressure balancer is normally positioned at the inlets of a mixer valve and operates so as to compensate the pressure variations of the water from the distribution mains and prevent flow fluctuations due to pressure variations, thereby maintaining constant mixed water ratios.

### OBJECTS AND SUMMARY OF THE INVENTION

The purpose of this invention is to supply a perfected piston type pressure balancer, simple embodiment and upgraded in terms of efficiency and reliability.

Such purpose is achieved, according to the invention, with a balancer in conformity with claim 1.

### BRIEF DESCRIPTION OF THE DRAWINGS

The invention is in any case described in more detail in the description that follows made with reference to the attached drawings, which are approximate and not limiting, in which:

FIG. 1 shows a section view of the pressure balancer associated with a mixer valve and with its piston in a centrally balanced position; and

FIGS. 2 and 3 show another section view of the pressure balancer with piston moved to opposite sides.

### DETAILED DESCRIPTION OF THE INVENTION

As shown, the pressure balancer consists of a balancer body 11 defining a chamber 12 in which is housed a floating piston 13. The chamber 12 is closed, on the one side, by an integral wall 14 and on the opposite side by a plug 15.

The chamber 12 of the body 11 comprises a middle section 16 and two side sections 17,18, one of which (17) on the side of the fixed wall 14, and the other (18) on the side of the plug 15 and delimited directly by the latter. All the middle and side sections 16,17,18 of the chamber 12 are substantially cylindrical and aligned along the same axis with each of the side sections open, towards the middle section. More specifically, the middle section has a larger diameter than that of the side sections, which are all identical.

The floating piston 13 comprises an intermediate flange 19 joined on opposite sides to two side flanges 20, 21 by means of a connection rod 22. The intermediate flange 19 has an external diameter compatible with that of the middle section 16 of the chamber 12 and bears a peripheral seal gasket 19′ on the inner surface of said middle section. The side flanges 20,21 each have a diameter corresponding to that of the side sections 17,18 of chamber 12 and consequently smaller than the diameter of the intermediate flange 19.

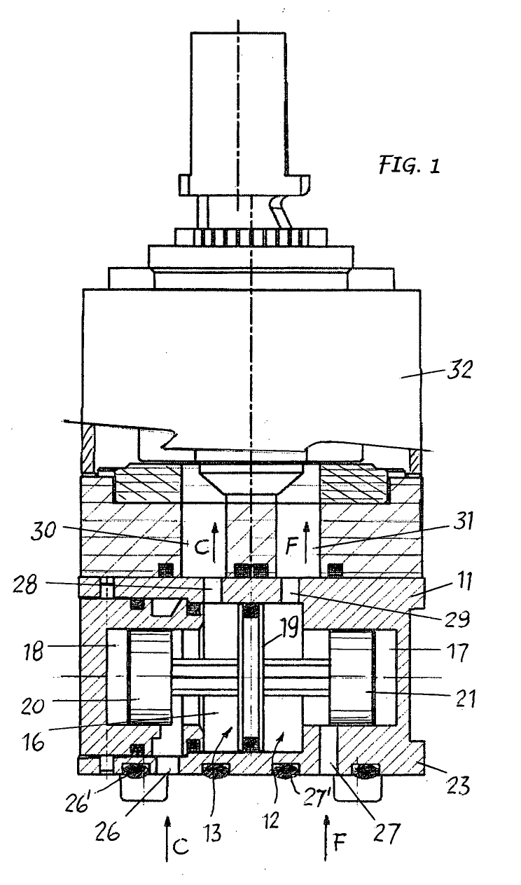

The body 11 of the balancer features a base wall 23 with two positioning feet 24 and an upper wall 25. In the base wall 24 are obtained, in line and communicating with the side sections 17, 18 of chamber 12, two openings 26,27 for the inflow of hot water C and cold water F. Around each opening 26, 27 a seal 26′, 27′ is fitted. In the upper wall 25 of the body two openings 28, 29 are obtained in opposite sides of the intermediate flange of the piston for outflow of the water towards the hot and cold water inlets 30, 31 of a mixer valve 32 associated with the balancer—FIG. 1.

The mixer valve 32 requires no description, as it can be of any known type.

The pressure balancer is located in the usual manner in a tap body, not shown, so its inlet openings 26, 27 coincide with the separate supply pipes for hot water C and cold water F connected to the body of the tap. The purpose of the feet 24 at the base of the balancer body is to correctly position the pressure balancer in the tap body, while the seals 26′, 27′ create a watertight seal between the base wall of the balancer body and the tap body.

The mixer valve 32 rests on the upper wall of the balancer body so its hot and cold water inlets 30, 31 coincide with the outlet openings 28,29 of the balancer itself.

Functionally, the intermediate flange 19 of the floating piston represents a wall dividing the transit flows of the hot water C from the transit flows of the cold water F in the pressure balancer. The range of movement of the intermediate flange in the middle section of the cavity in the balancer body covers the distance between the outlet opening of the hot and cold water towards the mixer valve and its peripheral seal prevents the water from seeping from one side to the other of said flange. The side flanges 20, 21 of the floating piston are adjacent to the inlet openings of the hot and cold water, respectively.

In these conditions, when the pressures of the hot and cold water are the same, the floating piston 12 remains in a balanced position as shown in FIG. 1 and the hot and cold water flow rates to the mixer valve remain constant. This ensures the ratios of the two types of water to be mixed do not vary and cause a variation in the temperature of the mixed water to be supplied to the user.

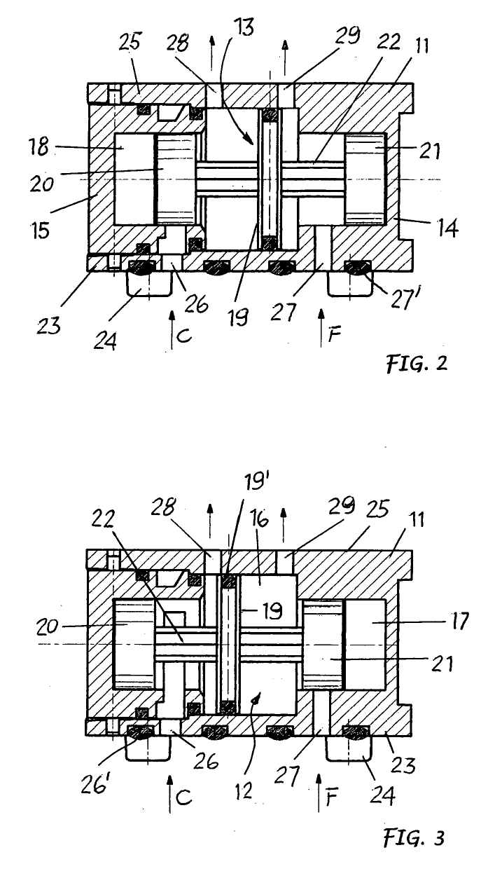

The balanced position of the floating piston does however change whenever the pressure of the hot and cold water changes. If the pressure of the hot water C increases, a greater hydrostatic thrust on the face of the intermediate flange 19 on the side of the transit flows of hot water causes a movement of the piston until the hot water inlet opening 26 is partially or even totally closed, while the flow rate of the two water flows is further or even totally opened as shown in FIG. 2. If the pressure of the cold water F increases, the piston moves to the opposite side as shown in FIG. 3 until the cold water inlet opening 27 is partially or totally closed, while the water inlet opening is further opened, thereby changing the hot and cold water ratios to maintain a constant temperature of the water during mixing.

Finally, it should be noted that each side flange 20,21 of the floating piston features a transversal hole that creates a fluid communication between the two opposite parts of the flange itself so as to balance the hydrostatic thrust on the faces themselves and ensure that only the force applied on the intermediate flange causes piston movements from one side to another according to the pressure differences between the hot and cold water flows.

1. Pressure balancer to be associated or integrated with a mixer valve featuring two separate inlets for hot and cold water and a mixed water outlet towards the user, comprising
a balancer body (11) having a base wall (23) and an upper wall (25) and defining a chamber (12) with closed ends,
a piston (13) housed and floating in said chamber, wherein:
said chamber (12) has a middle section (16) between two side sections (17, 18), cylindrical and aligned along a same axis, the middle section having a larger diameter than the side sections, which are identical with each other,
said piston (13) has an intermediate flange (19) joined at opposite ends to two side flanges (20, 21), the intermediate flange (19) having an external diameter compatible with that of said middle section (16) of said chamber (12) and featuring a peripheral seal (19′) on the inner surface of said middle section, and the side flanges (20, 21) each having a diameter corresponding to that of the side sections (17, 18) of said chamber (12) and therefore smaller than the diameter of said intermediate flange (19), and
in the base wall (23) of the balancer body (11) two openings (26, 27) are provided for the inflow of hot water and cold water respectively in said side sections (17, 18) of said chamber (12), and in the upper wall (25) of said balancer body, two openings (28, 29) are obtained on opposite sides of the intermediate flange (19) of the piston for the outflow of the hot and cold water from the middle section (16) of said chamber towards the hot and cold water inlets (30, 31) of said mixer valve (32),
the intermediate flange of the piston moves in the middle section of said chamber in the space between the hot and cold water outflow openings, while the side flanges of the piston move in the respective side sections of said chamber to open/close to a variable extent the inlet openings in response to the changes in pressure of the hot and cold water flows into the balancer.

2. Pressure balancer according to claim 1, wherein the intermediate flange has a diameter greater than the side flanges of said piston and each of said side flanges has a transversal hole for enabling communication of fluids between its opposite sides.

3. Pressure balancer according to claims 1 and 2, wherein said chamber (12) is closed at one end by an integral wall and at the opposite end by a plug, one of said side sections of said chamber being defined by said plug.

4. Pressure balancer according to claim 1, wherein at the base wall of the balancer body seals are fitted around the hot and cold water inlet openings.

5. Pressure balancer according to claim 4, wherein the base wall of the balancer body is provided with positioning feet.
